(19) United States
(12) Patent Application Publication
(10) Pub. No.: US 2011/0010026 A1
(43) Pub. Date: Jan. 13, 2011

(54) Calibration Method for Aerial Vehicles

(75) Inventors: Austin Jensen, Logan, UT (US); Yangquan Chen, Logan, UT (US)

Correspondence Address: UTAH STATE UNIVERSITY;TECHNOLOGY COMMERCIALIZATION OFFICE, 570 RESEARCH PARK WAY, SUITE 101, NORTH LOGAN, UT, 84341, US

(73) Assignee: Utah State University, North Logan, UT (US)

(21) Appl. No.: 12/835,417

(22) Filed: Jul. 13, 2010

Related U.S. Application Data
(60) Provisional application No. 61/225,023, filed on Jul. 13, 2009.

(51) Int. Cl. G05D 1/10

(52) U.S. Cl. 701/3

(57) ABSTRACT

Aerial vehicles make good remote sensing platforms by reducing the cost and making imagery easier to obtain. The low altitude, small image footprint and high number of images make it difficult and tedious to georeference the images based on features. Auto-orthorectification techniques based on the position and attitude of the aerial vehicle would work well except the inherent errors in the aerial vehicle sensors reduce the accuracy of the orthorectification significantly. The orthorectification accuracy is improved by calibrating the aerial vehicle sensors. This is done by inverse orthorectifing the images to find the actual position and attitude of the aerial vehicle using ground references setup in a square.

### RELATED APPLICATIONS

This application claims priotity to U.S. patent applicaiton Ser. No. 61/225,023 titled “USING AERIAL IMAGES TO CALIBRATE THE INERTIAL SENSORS OF A MULTISPECTRAL AUTONOMOUS REMOTE SENSING PLATFORM” filed on Jul. 13, 2009, which is incorporated herein by reference.

### FIELD OF THE INVENTION

This invention relates to a method for calibrating sensors, and in particular inertial sensors on a moving platform.

### BRIEF DESCRIPTION OF THE DRAWINGS

FIG. 1. Flow diagram for the calibration method

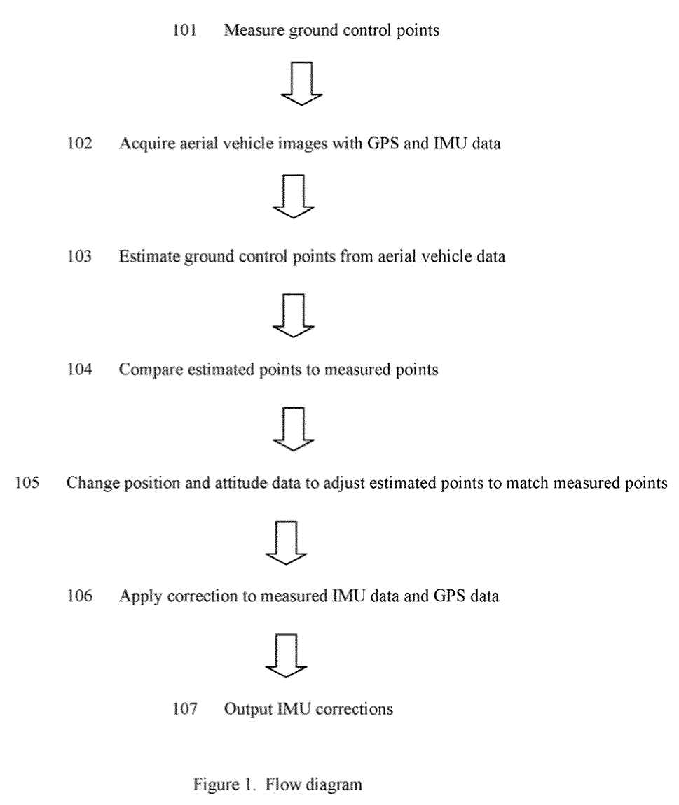

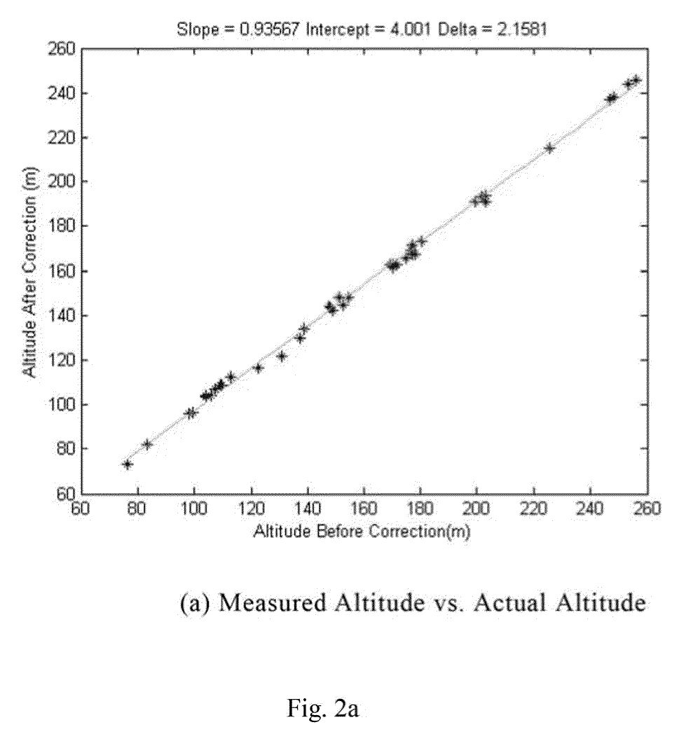

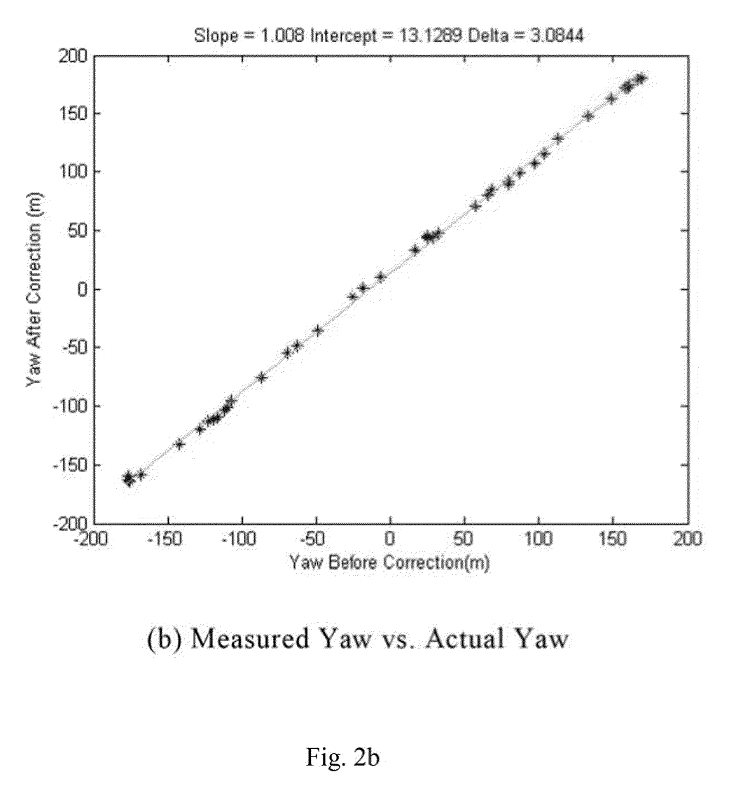

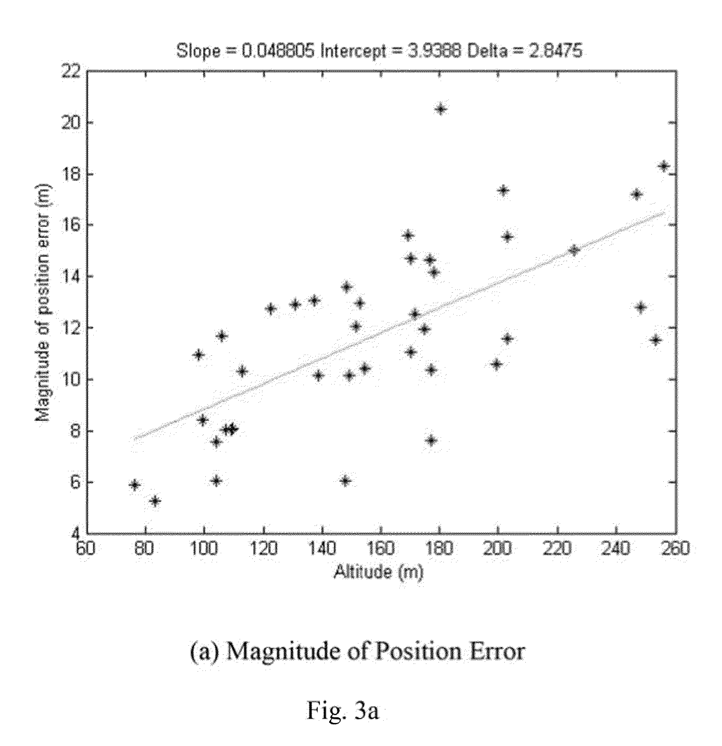

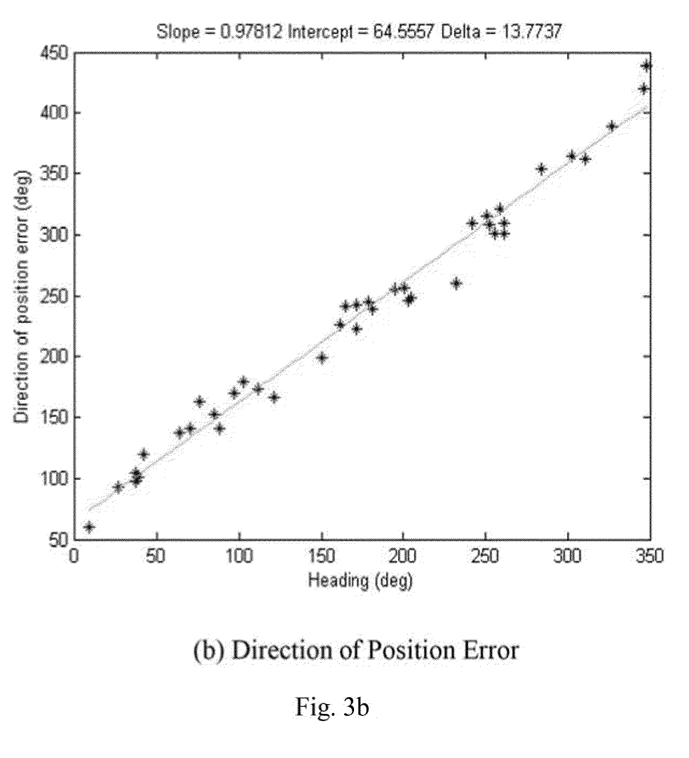

FIG. 2 Altitude and Yaw Graphs
(a) Measured Altitude vs. Actual Altitude
(b) Measured Yaw vs. Actual Yaw

FIG. 3. Position Error
(a) Magnitude of Position Error
(b) Direction of Position Error

### BACKGROUND

Small, low-cost unmanned aerial vehicles (UAVs) have proved to be useful sources of aerial imagery for remote sensing. Not only can they reduce the cost of remote sensing, but they can also increase the resolution and make the imagery easier to obtain. However, the low-cost aircraft sensors and the small image footprint introduce new challenges while georeferencing the images. As a result of the low altitude, normally flown by small UAVs, there are many cases where the small image footprint might lack features which could help tie the images to known control points on the ground. In a rural area, for example, some images might contain roads and buildings which can be tied to existing georeferenced images. However, unless ground targets are placed before the flight, most of the images likely contain featureless fields. Furthermore, placing ground targets in every image might also not be practical based on high number of images required to cover an area.

A method to automatically georeference images uses the position and attitude of the aircraft for orthorectification. However, the inherent errors in the inertial measurement unit (IMU) and the GPS receiver introduce errors in the orthorectification process (20-40 m). Some methods have been developed to improve this error for locating the position of a fixed ground target.

### DETAILED DESCRIPTION OF THE INVENTION

The method presented herein focuses on calibrating the IMU and the GPS module using aerial images and ground targets in order to improve the orthorectification accuracy. The ground targets are used to inverse orthorectify the images in order to find the actual attitude and position of the aerial vehicle (unmanned or manned). This data is then compared with the measured data and used to characterize the sensors. Once the sensors are calibrated, the orthorecification accuracy should improve for all the images taken from the aerial vehicle.

A point in the image plane (\vec{Pi}) can be transformed into Earth-Centered Earth-Fixed (ECEF) coordinates (\vec{Pw}) using the equation 1 below where \vec{Uw} is the position of the aerial vehicle in ECEF, R_{b}^{c} is the rotation matrix from the camera frame to the body frame, Rₙ^{b} is the rotation matrix from the body frame to the navigation frame, R_{w}ⁿ is the rotation matrix from the navigation frame to ECEF, and h is the height above ground of the aerial vehicle.

$$\vec{Pw} = {aR}_{w}^{n} {R}_{b}^{n} {R}_{b}^{c} \vec{Pl} + \vec{{U}_{w}} \\ a = \frac{h}{{\vec{V}}_{z}^{T} {R}_{n}^{b} {R}_{b}^{c} \vec{Pl}} \\ {\vec{V}}_{z} = [ \begin{matrix}0 \\ 0 \\ 1\end{matrix} ] . \qquad Equation 1$$

There is a possibility that the equation could be used directly to find the position and attitude of the aerial vehicle given multiple known ground control points (\vec{Pw}) and their positions on an image (\vec{Pi}). However, this could prove to be very complicated. One embodiment of the method presented here takes an approach by setting up the ground control points in a square. The properties of this square, where the locations of the corners are measured, can be compared to the properties of another square where the corner positions are estimated using the above equation. By changing the position and attitude of the aerial vehicle, the properties of the estimated square can be adjusted to match the properties of the measured square. The correct position and attitude of the aerial vehicle is found when the properties of the measured and estimated squares match. For example, the difference between the areas of each square reflects the measured and actual altitude of the aerial vehicle above ground. If the measured square has an area greater than the area of the estimated square, the altitude of the aerial vehicle needs to be increased. The estimated square is then recalculated using equation 1 and the areas are compared again. Once the areas match, the correct altitude is found.

The position and yaw of the aerial vehicle are easier to find than the altitude. This is because the difference in the position and orientation of the squares are directly related to the difference between the measured and actual position and yaw of the aerial vehicle. Therefore, the difference between the position and orientation of the squares are added to the measured values of the position and yaw of the aerial vehicle to find the actual position and yaw.

The shape, the length of each side and the length of the diagonals could all have a relationship to roll and pitch. However, this relationship depends on the orientation of the square relative to the image.

Ground markers are laid out in a set pattern, clearly visible to the aircraft as it flies overhead. The true position of each ground marker is measured from the ground and recorded 101.

Images of the ground markers are recorded during flight of the aerial vehicle 102. Together with the images data from the IMU and GPS are recorded. The IMU and GPS data are used to compute position, attitude and altitude of the aircraft.

The image data, IMU data and GPS data are used to compute the position of the ground markers as seen by the aircraft 103. These computed positions (also referred to as estimates) are compared to the true position data measured for the ground targets 104.

The position, altitude and attitude data are adjusted to make the computed position of the ground targets match the true position of each ground marker 105. The aggregate data set of measured positions using aerial images and the true positions form the ground data can be treated an ensemble with minimum errors measured for each position and for the ensemble of position data. The definition of minimum error can take a number of definitions commonly used in fitting procedures such as minimum mean square error, minimum-variance unbiased estimator, or other minimum estimators used for an ensemble of data points.

The determined error in IMU and GPS data is recorded 107 as the operational corrections used in further data analysis within the greater image data set 106.

### VALIDATING THE CORRECTION METHOD

In order to maximize the amount of space covered by the square in each image, regardless of the flight altitude, three squares were placed on the ground with various dimensions. The dimensions of the squares were 25×25 m, 50×50 m and 100×100 m. After the targets were laid out and measured, the aerial vehicle was flown over them 60 times at different altitudes and headings. However, due to the 4 second sample time of the cameras, some of the images only captured part of the square and could not be used for the experiment. After filtering out the bad ones, there were still 40 good images to use. Also, in some of the images, the corners of the other squares were captured and could be used to test the orthorectification accuracy outside of the square.

The control points in are at the corners of the squares with extra control points outside the square. The errors of the control points before any correction varied from 5 m to 45 m. Correcting for the altitude did not show any significant improvement. However, correcting for the orientation reduced the error to 5 m-20 m, and correcting for position reduced the errors to 0 m-3 m. One thing to not is that the errors of the control points outside the square are higher (0 m-6 m), after correcting for position, than the errors of the control points which make up the square. This is probably because of the fact that the roll and the pitch were not yet corrected. Some of the position error created by distortions in the roll and pitch are being compensated for in the control points contained in the square; however these distortions are still apparent outside the square.

As shown by FIG. 2, a clear relationship can be found between the measured and the actual altitude and yaw of the aerial vehicle. The altitude has a small bias of 4 meters. In addition, the slope of the graph shows that the error in the altitude worsens as it becomes larger. The yaw has a bias of 13 degrees and a slope of 1.

FIG. 3(a) shows the relationship between the magnitude of the position error and the altitude. As expected, the error increases as the altitude increases. This relationship is better defined when the roll and pitch are compensated for. This is even more apparent in FIG. 3(b) where the direction of the position error is always about 64 degrees greater than the heading of the aircraft. This also may be due to a bias in the roll and pitch which can be induced by a small misalignment between the camera and the body of the aircraft. Namely, the cameras could be slightly rotated around the x and y axis of the aircraft to point 64 degrees from the nose.

The results show that the measured altitude, yaw and position of the UAV can be corrected and used to characterize the onboard sensors using known ground control points setup in a square. Even though this method improved the orthorectification accuracy from 45 m to 5 m, adding roll and pitch compensation could further improve the accuracy and make the relationship between the position errors more clear. GPS quality could be a big factor in changing the calibration on a day to day basis.

What is claimed is:

1. A method for calibrating aerial vehicles comprising:
measuring ground control points;
acquire aerial vehicle images with measured GPS and IMU data;
estimating ground control points from said aerial vehicle data;
comparing said estimated points to said measured points;
changing position and attitude data to adjust said estimated points to match said measured points; and
applying correction to said measured IMU data.

2. The method for calibrating aerial vehicles of claim 1 further comprising:
outputting IMU corrections.

3. The method for calibrating aerial vehicles of claim I further comprising:
applying said correction to said measured GPS data.

4. The method for calibrating aerial vehicles of claim 3 further comprising:
outputting GPS corrections.

5. The method for calibrating aerial vehicles of claim I wherein:
outputting IMU corrections.

6. A method for calibrating aerial vehicles comprising:
measuring ground control points;
acquire aerial vehicle images with measured GPS and IMU data;
a) estimating ground control points from said aerial vehicle data;
b) comparing said estimated points to said measured points;
c) computing correction to IMU and GPS data to improve alignment of said estimated points to said measured points;
d) calculating new estimation of position and attitude data; and
applying said correction to said measured IMU data.

7. The method for calibrating aerial vehicles of claim 6 further comprising:
outputting IMU corrections.

8. The method for calibrating aerial vehicles of claim 6 further comprising:
applying said correction to said measured GPS data.

9. The method of claim 6 further comprising:
steps a), b), c) and d) are iterated; and
identifying said new correction to IMU data.

10. The method for calibrating aerial vehicles of claim 9 further comprising:
outputting IMU corrections.

11. The method for calibrating aerial vehicles of claim 9 further comprising:
applying said correction to said measured GPS data.
